(19) United States
(12) Patent Application Publication
(10) Pub. No.: US 2026/0040037 A1
(43) Pub. Date: Feb. 5, 2026

(54) LOCATION BASED SERVICE MESSAGE COMMUNICATION

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/789,969

(22) Filed: Jul. 31, 2024

(51) Int. Cl. H04W 4/12; G06F 40/205; H04W 4/02; H04W 12/062

(52) U.S. Cl. CPC H04W 4/12; H04W 4/023; G06F 40/205; H04W 12/062

(57) ABSTRACT

In aspects of location based service message communication, a first mobile device determines a date, a time, and a location associated with service data of a service message. The first mobile device can identify a second mobile device linked to the first mobile device via a collaborative space accessible by the first mobile device and the second mobile device. The first mobile device may determine a first location of the first mobile device and receive a second location of the second mobile device via the collaborative space. At the date and the time, the first mobile device may determine that the first location does not match the location associated with the service message and the second location matches the location associated with the service message. In response to this determination, the first mobile device may share the service message with the second mobile device.

### BACKGROUND

Devices, such as smart devices, mobile devices (e.g., cellular phones, tablet devices, smartphones), consumer electronics, and the like, can be implemented for use in a wide range of environments and for a variety of different applications. For example, a device can implement an online service application, such as a marketplace application that allows a user to purchase items. The online service application can include a user interface for displaying products, services, and the like, to the user. The user may interact with the user interface to purchase products for delivery or pickup, purchase a service to be performed at a specific location, to request a product return pickup, to receive personalized product recommendations, to receive notifications related to the marketplace application, and more. Services ordered by the user may be performed at a physical location, such as at a place of residence of the user. Although there is convenience associated with the ease of purchasing services through an online service application, it is not without limitations. For example, a user who ordered the service may not be physically present when the service is to be performed.

### BRIEF DESCRIPTION OF THE DRAWINGS

Implementations of the techniques for location based service message communication are described with reference to the following Figures. The same numbers may be used throughout to reference like features and components shown in the Figures.

FIGS. 1 and 2 illustrate example systems for location based service message communication in accordance with one or more implementations as described herein.

FIGS. 3 through 8 illustrate example graphical user interfaces (GUIs), which support location based service message communication in accordance with one or more implementations as described herein.

FIGS. 9 and 10 illustrate example methods for location based service message communication in accordance with one or more implementations of the techniques described herein.

FIG. 11 illustrates various components of an example device that can be used to implement the techniques for location based service message communication as described herein.

### DETAILED DESCRIPTION

Implementations of techniques for location based service message communication are described herein. In some examples, a user may order a service from an online service application. For example, the user may order a service such as a product delivery, request a product return pickup, request a service agent to perform a repair, and/or order any other service. The online service application may initiate performance of the service at a physical location of the user. For example, the user may specify a service location (e.g., address), a service date, and/or a service time when requesting a service from the online service application. A service agent of the online service application may perform the service at the specified service location, date, and time. In some examples, the user who ordered the service may not be physically present at the service location during the specified service time on the service date, and the service agent may have to wait to perform the service. For example, if the user who ordered a product return pickup is not physically present at the service location at the specified date and time, the service agent may not be capable of performing the product return pickup. Alternatively or in addition, if the user who ordered a product return pickup is not physically present at the service location at the specified date and time, the service agent may be given an incorrect product to return by an alternative occupant of the service location.

Thus, one solution to reduce or prevent delayed or incorrectly performed services involves sending a service message to the user who requested a service. The service message may include service data indicative of the nature of the service, such as a service time, a service date, and a service location. Alternatively or in addition, the service message may include an authentication code that must be communicated to a service agent when the service agent is physically present at the service location when the service is scheduled to take place. However, these solutions fail to remedy shortcomings when the user who requested the service is not physically present at the service location when the service is to take place. Thus, location based service message communication is required to remedy the shortcomings of these conventional techniques.

As described herein, a first mobile device may receive a service message and automatically forward the service message to a second mobile device if the first mobile device is not physically present at the service location during the service. In implementations, the service message may be automatically shared via a collaborative space. The collaborative space may be implemented by any kind of device external to the first mobile device, or as an application internal to the first mobile device and/or the second mobile device. The collaborative space may link the first mobile device to the second mobile device and any other devices and/or users such that information in the collaborative space may be accessed by one or more of the linked devices and/or users. In implementations, the collaborative space may selectively share information in the collaborative space with linked devices and/or users, such as through a priority list.

As described herein, the first mobile device can receive a message and parse the received message to ascertain the received message is a service message and extract service data including a service time, a service date, and a service location. For example, the first mobile device may implement a communication manager that utilizes a form of text recognition software, optical character recognition software, machine learning algorithm(s), and/or artificial intelligence algorithms. The first mobile device may communicate the service message to the collaborative space which implements a service message manager to store the service message and service data until the service date and/or the service time. When the service date and/or the service time arrives, the service message manager implemented by the collaborative space can determine to which device(s) and/or user(s) the service message is communicated by comparing location information of mobile devices to the service location. For example, if the first mobile device is not physically present at the service location and/or is otherwise unavailable while the second mobile device is physically present at the service location and/or is available, the service message manager may communicate the service message to the second mobile device. In implementations, the service message manager may communicate the service message in accordance with the priority list. For example, if both the second mobile device and a third mobile device are available at the service location during the service date and the service time, the service message manager can share the service message with the second mobile device if the second mobile device is higher on the priority list than the third mobile device.

While features and concepts of the described techniques for location based service message communication can be implemented in any number of different devices, systems, environments, and/or configurations, implementations of the techniques location based service message communication are described in the context of the following example systems, user interfaces, process flows, methods, and devices.

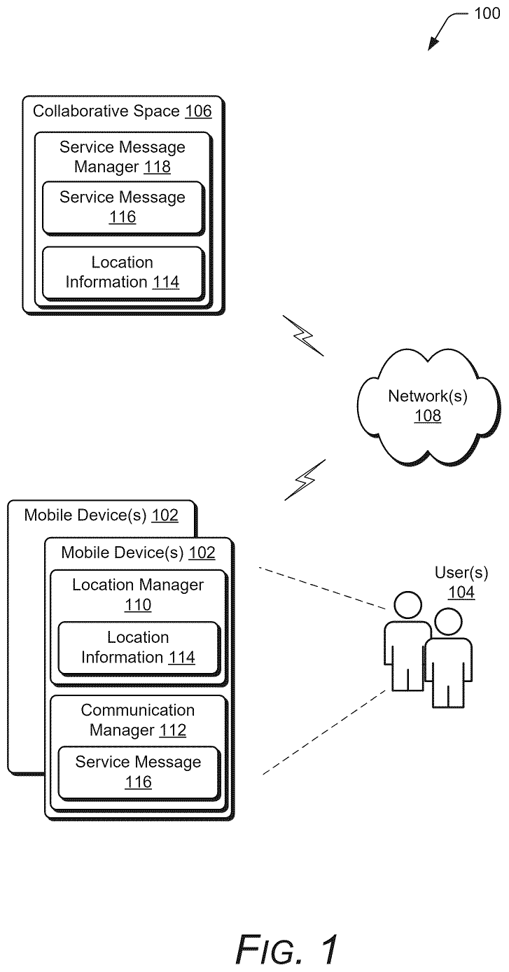

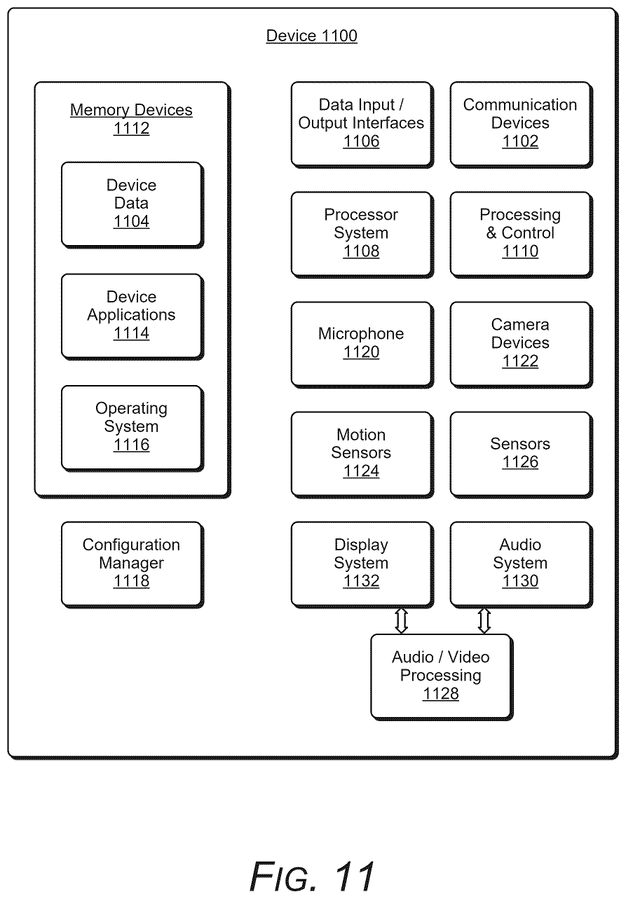

FIG. 1 illustrates an example system 100 for location based service message communication, as described herein. The example system 100 includes one or more mobile devices 102, one or more users 104 of the mobile devices 102, and a collaborative space 106, where the client devices and the collaborative space are interconnectable via one or more networks 108. In implementations, the mobile devices 102 include a smartphone, a mobile phone, and/or any other type of wireless device. The mobile devices 102 can be implemented with various components, such as a processor system and memory, as well as any number and combination of different components as further described with reference to the example device shown in FIG. 11. In implementations, the mobile devices 102 include various radios for wireless communication with other devices (e.g., via the one or more networks 108). For example, the mobile device 102 may include a Bluetooth (BT) and/or Bluetooth Low Energy (BLE) transceiver and/or a near field communication (NFC) transceiver. The mobile device 102 can also include a Wi-Fi radio, a global positioning system (GPS) radio, a radio for cellular communication (e.g., a third generation (3G) network, a fourth generation (4G) network, a fifth generation (5G) network), and/or any type of device communication interfaces.

The mobile devices 102 include various functionality that enables the mobile devices 102 to perform different aspects of location based service message communication, as described herein, including a location manager 110 and a communication manager 112. The location manager 110 represents functionality (e.g., logic and hardware) for enabling the mobile device 102 to collect location information 114 related to a geographic location of a user 104 of the mobile device 102 and/or related to an availability status of the user 104 of the mobile device 102 at the time of a service. The location manager 110 collects application data, system data, and/or geographic data to determine the location information 114. For example, the location manager 110 collects data from one or more of a scheduling application that tracks a calendar or schedule of the user 104, a tracking application that includes a geographical location of the user, applications that allow a user to tag a location, or messaging applications that include data related to travel plans or location of the user, among others. Additionally, or alternatively, the location manager 110 collects system information related to the mobile device 102 of a user 104, the system information including one or more of an airplane mode status of the mobile device or a network connectivity status of the mobile device, among other settings that can indicate a location of the user 104 and/or an availability status of the user (e.g., whether the user is busy in a meeting, on a plane, etc.). Additionally, or alternatively, the location manager 110 collects GPS data indicating the location of the mobile device 102. For example, a user may enable one or more applications or services at the mobile device 102 that enable the mobile device to track a geographical location or availability status.

The communication manager 112 represents functionality (e.g., logic and hardware) for enabling the mobile device 102 to interconnect with other devices and/or one or more networks, such as the one or more networks 108. The communication manager 112, for instance, enables wireless and/or wired connectivity of the mobile device 102. For example, the communication manager 112 represents one or more antennas for transmitting and receiving signaling from other devices via the one or more networks 108. In implementations, the communication manager 112 can receive a message and determine that the received message is a service message 116. For example, the communication manager 112 can implement text recognition software, optical character recognition software, machine learning algorithm(s), and/or artificial intelligence algorithm(s) to determine that the received message is the service message 116. The communication manager 112 can parse the service message 116 to extract a date, a time, and/or a location of the service to be performed in the service message. For example, the mobile device 102 may receive the service message 116, and the communication manager 112 can determine that a delivery is to take place at a certain location, time, and/or date. Alternatively or in addition, the mobile device 102 may receive the service message 116, and the communication manager 112 can determine that a product return pickup is to take place at a certain location, time, and/or date. Alternatively or in addition, the mobile device 102 may receive the service message 116, and the communication manager 112 can determine that a repair or other type of service is to take place at a certain location, time, and/or date. Alternatively or in addition, the mobile device 102 may receive the service message 116, and the communication manager 112 can determine an authentication code for a service to be performed in the service message, such as a one-time password (OTP). In implementations, the communication manager 112 may cause the mobile device 102 to transmit the service message 116 to the collaborative space 106 over the one or more networks 108 in response to determining that the received message is the service message and extracting the service data.

The one or more networks 108 can include computer networks and/or telecommunication networks. For example, the one or more networks 108 can include a wireless local area network (WLAN), a wireless network, a BT network, a cellular network, a satellite network, and/or a fiber optic network. The one or more networks 108 connect one or more devices, such as the mobile devices 102 and the collaborative space 106, among others.

The collaborative space 106 provides for location based service message communication in one or more implementations. For example, the collaborative space 106 can be a database, a server device, and/or any combination of devices that can store data, manipulate data, and/or provide for access of data for one or more devices, such as the mobile devices 102. In implementations, the collaborative space 106 may be an example of a remote database (e.g., cloud or network-based database), a physical database, or the like. In some examples, the collaborative space 106 can be hosted at one of the mobile devices 102 as an application, module, and/or local database. The collaborative space 106 can store the location information 114 collected at the mobile devices 102. Alternatively or in addition, the collaborative space 106 can be one or more of a web server, an application server, or a cloud server, among others. The collaborative space 106 includes various functionality that enables the mobile device 102 to perform different aspects of location based service message communication discussed herein, including a service message manager 118. The service message manager 118 represents functionality (e.g., logic and hardware) implemented by the collaborative space 106 as an external device or internal to the mobile devices 102 for enabling the collaborative space 106 to collect the service message 116 and/or service data from the mobile device 102, store the service message and/or service data, transmit the service message 116 and/or service data to the mobile devices 102, and/or any combination thereof.

In implementations, the service message manager 118 implemented by the collaborative space 106 may transmit the service message 116 to one or more mobile devices 102 over the one or more networks 108 based on the location information 114 and the service data including the service location, service date, and/or service time. For example, the service message manager 118 may receive the service message 116 with service data indicating a service is to take place at a certain location, time, and date. The service message manager 118 may determine that the location information 114 from the mobile device(s) 102 matches the service location of the service data extracted from the service message 116 and transmit the service message to the mobile device(s) at the service date and/or the service time. In this manner, the collaborative space 106 can communicate the service message 116 to the mobile device(s) 102 that are physically located where the service in the service messages is taking place.

In some implementations, the users 104 may represent users on a priority list of users associated with the mobile devices 102. The priority list may represent a list of users 104 who are preferred to receive the service message 116 in order of priority. A user 104 of the mobile device 102 may specify a list of users authorized to receive the service message 116. In implementations, a user 104 of the mobile device 102 may also specify a priority order along with the list of users authorized to receive the service message 116. For example, the user 104 may specify the priority list of authorized users via a GUI, or other user interface, of the mobile device 102. Alternatively or in addition, the mobile device 102, the collaborative space 106, or both can autonomously determine the priority list of authorized users (e.g., independent of user input), such as by analyzing historical delivery information or data to detect additional users 104 at a delivery location. For example, the historical delivery information can include one or more of a list of previous users 104 who received one or more service messages 116 with service data indicating the same service location or historical user input indicating a priority list of authorized users (e.g., that are authorized to receive service messages at the same service location), among other data. The priority list of authorized users can be stored at the collaborative space 106.

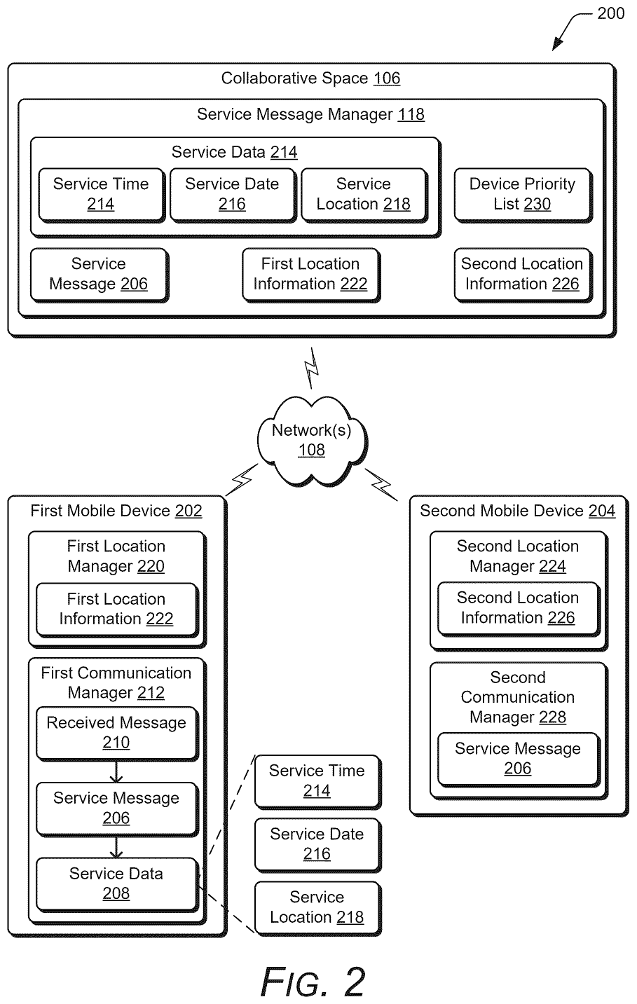

FIG. 2 illustrates an example system 200 for location based service message communication in accordance with one or more implementations as described herein. The example system 200 may implement aspects of the example system 100 described with reference to FIG. 1. The example system 200 may include the collaborative space 106, the one or more networks 108, and a first mobile device 202 and a second mobile device 204 that may correspond to the mobile devices 102 associated with the users 104, which are examples of the corresponding features as described with reference to FIG. 1. As discussed above, in some examples the collaborative space 106 may be a remote database (e.g., cloud or network-based database), a physical database, or the like. Additionally, or alternatively, the collaborative space 106 can be hosted at one of the mobile devices 102 as an application, module, and/or local database.

In implementations of location based service message communication as described herein, the first mobile device 202 and the second mobile device 204 are configured to run one or more applications. For example, the first mobile device 202 and the second mobile device 204 may have GUIs that display applications to user(s) of the first mobile device 202 and the second mobile device 204. The applications may include an application to access and display the collaborative space 106 accessible to the first mobile device 202 and the second mobile device 204. In implementations, the applications may also include online service applications that offer services to a user of the first mobile device 202 and/or the second mobile device 204, such as an online marketplace application for purchasing products. In implementations, the online service applications may prompt a user of the first mobile device 202 and/or the second mobile device 204 to select one or more of a service time, a service date, and service location. Alternatively or in addition, the online service application selects the service time, the service date, and/or the service location. For example, a user of the first mobile device 202 can utilize the online service application to perform a product return at a particular service time, a particular service date, and/or a particular service location. The online service application can generate a service message 206 with service data 208 that includes the particular service time, the particular service date, and/or the particular service location to communicate to the first mobile device 202.

The first mobile device 202 may receive the service message 206 as a received message 210 from the online service application. The first mobile device 202 may implement a first communication manager 212 to receive the received message 210, determine the received message is the service message 206, and extract the service data 208 from the service message 206. The service data 208 is illustrated as a service time 214, a service date 216, and/or a service location 218. For example, the first communication manager 212 can implement text recognition software, optical character recognition software, machine learning algorithm(s), and/or artificial intelligence algorithm(s) to determine that the received message 210 is the service message 206. The first communication manager 212 can further parse the service message 206 to extract the service time 214, the service date 216, and/or the service location 218 of the service to be performed in the service message. For example, the first mobile device 202 may receive the received message 210, and the first communication manager 212 can determine that a product return pickup is to take place at the service time 214, the service date 216, and/or the service location 218. The first communication manager 212 may initiate a transmission of the service message 206 with the service data 208 to the collaborative space 106 in response to extracting the service data 208.

The first mobile device 202 may also implement a first location manager 220 to determine first location information 222 of the first mobile device 202. The first location manager 220 represents functionality (e.g., logic and hardware) for enabling the first mobile device 202 to collect the first location information 222 related to a geographic location of a user of the first mobile device 202 and/or related to an availability status of the user of the first mobile device 202 at the service time 214. The first location manager 220 collects application data, system data, and/or geographic data to determine the first location information 222. For example, the first location manager 220 collects data from one or more of a scheduling application that tracks a calendar or schedule of the user associated with the first mobile device 202, a tracking application that includes a geographical location of the user, applications that allow a user to tag a location, or messaging applications that include data related to travel plans or locations of the user, among others. Additionally, or alternatively, the first location manager 220 collects system information related to the user of the first mobile device 202, the system information including one or more of an airplane mode status of the first mobile device or a network connectivity status of the first mobile device, among other settings that can indicate a location of the user and/or an availability status of the user (e.g., whether the user is busy in a meeting, on a plane, etc.). Additionally, or alternatively, the first location manager 220 collects GPS data indicating the location of the first mobile device 202. For example, a user may enable one or more applications or services at the first mobile device 202 that enable the mobile device to track a geographical location or availability status. The first mobile device 202 may transmit the first location information 222 to the collaborative space 106 over the one or more networks 108 at various intervals or in response to various events, such as continuously, periodically, and/or in response to a request from the collaborative space.

In implementations, the second mobile device 204 may also implement a second location manager 224 to determine second location information 226 of the second mobile device. The second location manager 224 represents functionality (e.g., logic and hardware) for enabling the second mobile device 204 to collect the second location information 226 related to a geographic location of a user of the second mobile device 204 and/or related to an availability status of the user of the second mobile device 204 at the service time 214. The second location manager 224 collects application data, system data, and/or geographic data to determine the second location information 226. For example, the second location manager 224 collects data from one or more of a scheduling application that tracks a calendar or schedule of the user associated with the second mobile device 204, a tracking application that includes a geographical location of the user, applications that allow a user to tag a location, or messaging applications that include data related to travel plans or location of the user, among others. Additionally, or alternatively, the second location manager 224 collects system information related to the user of the second mobile device 204, the system information including one or more of an airplane mode status of the second mobile device or a network connectivity status of the second mobile device, among other settings that can indicate a location of the user and/or an availability status of the user (e.g., whether the user is busy in a meeting, on a plane, etc.). Additionally, or alternatively, the second location manager 224 collects GPS data indicating the location of the second mobile device 204. For example, a user may enable one or more applications or services at the second mobile device 204 that enable the mobile device to track a geographical location or availability status. The second mobile device 204 may transmit the second location information 226 to the collaborative space 106 over the one or more networks 108 at various intervals or in response to various events, such as continuously, periodically, and/or in response to a request from the collaborative space.

The collaborative space 106 can implement the service message manager 118 to receive, store, process, and/or transmit the service message 206 with the service data 208 including the service time 214, the service date 216, and the service location 218. The collaborative space 106 may also implement the service message manager 118 to receive, store, manage, and/or transmit the first location information 222 and/or the second location information 226. For example, the service message manager 118 may communicate the service message 206 to the second mobile device 204 based on the service data 208 and the second location information 226. The service message manager 118 can determine that the second location information 226 matches the service location 218 at the service time 214 and/or the service date 216. In response to this determination, the service message manager 118 may initiate a transmission of the service message 206 to the second mobile device 204 over the one or more networks 108. Alternatively or in addition, the service message manager 118 may initiate the transmission of the service message 206 to the second mobile device 204 in response to determining that the first location information 222 does not match the service location 218.

In implementations, the second mobile device 204 may receive the service message 206 by a second communication manager 228 and display the service message on a GUI of the second mobile device 204. The GUI of the second mobile device 204 may be accessible through an application to display the service message 206 via the collaborative space 106.

In this manner, the service message manager 118 ensures delivery of the service message 206 to a user of a mobile device that is physically located at the service location 218 at the service date 216 and/or the service time 214. For example, a user of the first mobile device 202 may initiate a product return pickup from a home location via an online service application. The online service application may communicate the received message 210 (i.e., the service message 206) outlining the service data 208 of the product return pickup to the first mobile device 202. The service message manager 118 can automatically send the service message 206 to the second mobile device 204 in the event the second mobile device 204 is at the home location but the first mobile device 202 is not at the home location at the service time 214 and/or the service date 216 outlined in the service message.

Alternatively or in addition, the service message manager 118 implemented by the collaborative space 106 may initiate a communication of the service message 206 back to the first mobile device 202 in the event that the first location information 222 matches the service location 218 at the service time 214 and/or the service date 216. In this example implementation, the second location information 226 may or may not match the service location 218 at the service time 214 and/or the service date 216. The first mobile device 202 may receive the service message 206 by the first communication manager 212 and display the service message on a GUI of the first mobile device 202. The GUI of the first mobile device 202 may be accessible through an application to display the service message 206 via the collaborative space 106.

In implementations of location based service message communication as described herein, the service message manager 118 may initiate a transmission of the service message 206 according to a device priority list 230. The device priority list 230 may represent a list of users and/or mobile devices (e.g., the first mobile device 202 and the second mobile device 204). For example, a user of the first mobile device 202 may specify a list of users and/or devices that are authorized to receive the service message 206. In implementations, a user of the first mobile device 202 may also specify a priority order along with the lists of users and/or devices authorized to receive the service message 206. For example, the user of the first mobile device 202 may specify the priority list of authorized users via a GUI, or other user interface, of the first mobile device 202. Alternatively or in addition, the mobile device 202, the collaborative space 106, or both can autonomously determine the device priority list 230 of authorized users (e.g., independent of user input), such as by analyzing historical delivery information or data to detect additional users and/or devices (e.g., the second mobile device 204) at the service location 218. For example, the historical service information can include one or more of a list of previous users and/or devices that received one or more service messages 206 with service data 208 indicating the same service location 218 or historical user input indicating the device priority list 230 of authorized users (e.g., that are authorized to receive service messages at the same service location), among other data. The device priority list 230 of authorized users can be stored at the collaborative space 106.

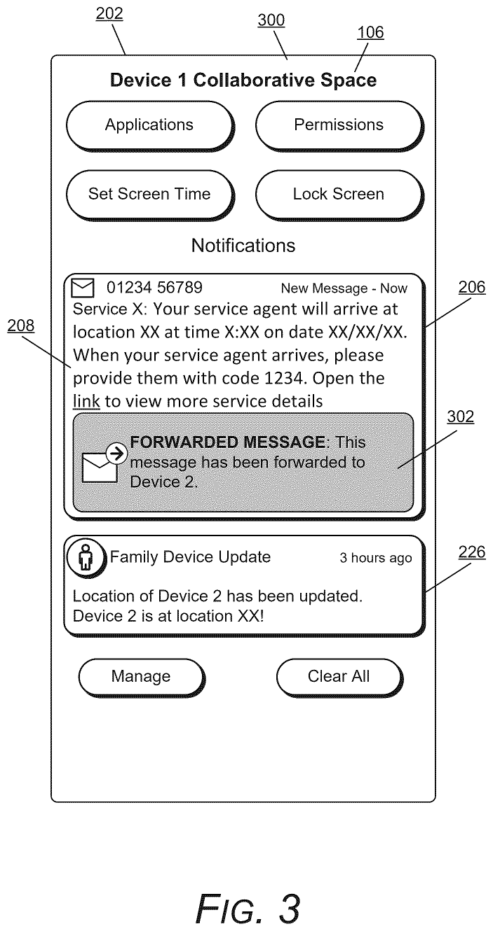

FIG. 3 illustrates an example GUI 300, which supports location based service message communication in accordance with one or more implementations as described herein. The example GUI 300 may implement aspects of the example system 100, as well as the example system 200 as shown and described with reference to FIGS. 1 and 2. For example, the GUI 300 may illustrate an example of the service message 206 displayed at the first mobile device 202 and/or the mobile device 102 that has been automatically communicated and/or forwarded to the second mobile device 204 as described with reference to FIGS. 1 and 2

In the example GUI 300, the first mobile device 202 displays the service message 206 for a user of the first mobile device to view in the collaborative space 106. In this example GUI 300, the service message 206 includes information, such as the service data 208, indicating the service requires an authentication code, such as an authentication code to perform a repair. The first mobile device 202 can alert the user of the service message 206, such as by an audio alert, a visual alert, a haptic alert, or any other type of alert. In some examples, the service message 206 includes a banner 302 and/or other alert that indicates to the user of the first mobile device 202 that the service message 206 has been automatically forwarded by the collaborative space 106 to the second mobile device 204.

In some examples, the GUI 300 also includes the service data 208 which may include the service time 214, the service date 216, and/or the service location 218. In this example GUI 300, the second mobile device 204 is associated with the second location information 226 that is matched with the service location 218 such that the service message 206 is automatically communicated to the second mobile device 204 at the service time 214 and/or the service date 216 in accordance with the techniques as described with reference to FIGS. 1 and 2. The GUI 300 may also receive user input to access service details, such as the service data 208, through an interactive link, such as a link to view the repair to be performed.

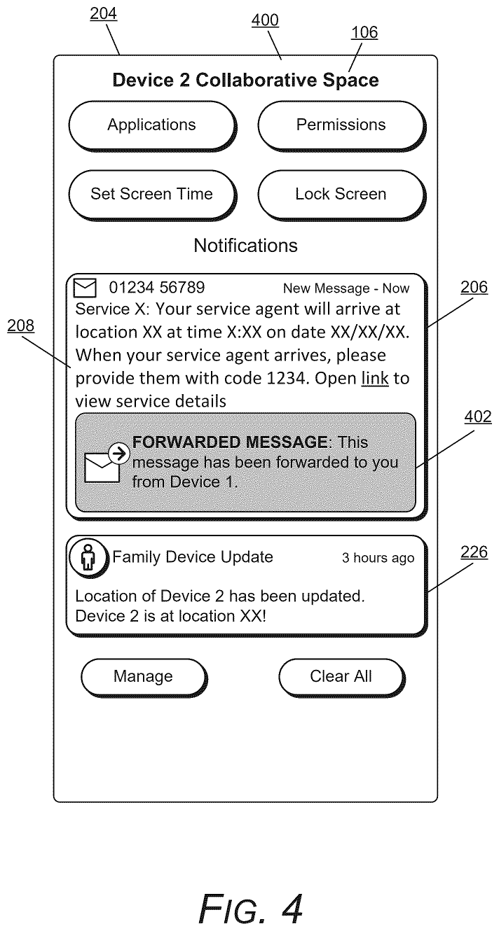

FIG. 4 illustrates an example GUI 400, which supports location based service message communication in accordance with one or more implementations as described herein. The example GUI 400 may implement aspects of the example system 100, as well as the example system 200 as shown and described with reference to FIGS. 1 and 2. For example, the GUI 400 may illustrate an example of the service message 206 displayed at the second mobile device 204 and/or the mobile device 102 that has been automatically communicated and/or forwarded to the second mobile device as described with reference to FIGS. 1 and 2

In the example GUI 400, the second mobile device 204 displays the service message 206 for a user of the second mobile device to view in the collaborative space 106. In this example GUI 400, the service message 206 includes information, such as the service data 208, indicating the service requires an authentication code, such as an authentication code to perform a repair. The second mobile device 204 can alert the user of the service message 206, such as by an audio alert, a visual alert, a haptic alert, or any other type of alert. In some examples, the service message 206 includes a banner 402 and/or other alert that indicates to the user of the second mobile device 204 that the service message 206 has been automatically forwarded by the collaborative space 106 to the second mobile device 204 from the first mobile device 202.

In some examples, the GUI 400 also includes the service data 208 which may include the service time 214, the service date 216, and/or the service location 218. In this example GUI 400, the second mobile device 204 is associated with the second location information 226 that is matched with the service location 218 such that the service message 206 is automatically communicated to the second mobile device at the service time 214 and/or the service date 216 in accordance with the techniques as described with reference to FIGS. 1 and 2. The GUI 400 may also receive user input to access service details, such as the service data 208, through an interactive link, such as a link to view the repair to be performed.

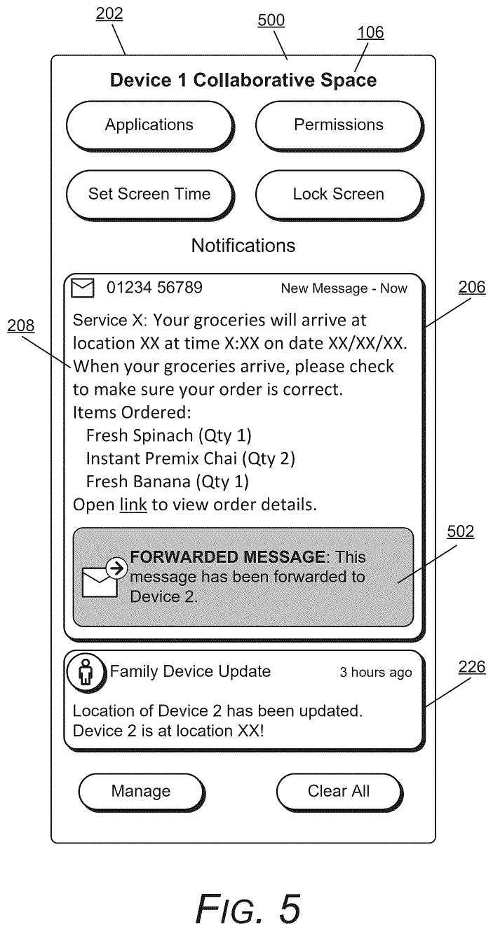

FIG. 5 illustrates an example GUI 500, which supports location based service message communication in accordance with one or more implementations as described herein. The example GUI 500 may implement aspects of the example system 100, as well as the example system 200 as shown and described with reference to FIGS. 1 and 2. For example, the GUI 500 may illustrate an example of the service message 206 displayed at the first mobile device 202 and/or the mobile device 102 that has been automatically communicated and/or forwarded to the second mobile device 204 as described with reference to FIGS. 1 and 2

In the example GUI 500, the first mobile device 202 displays the service message 206 for a user of the first mobile device to view in the collaborative space 106. In this example GUI 500, the service message 206 includes information, such as the service data 208, indicating that the service is a product delivery, such as a grocery delivery. The first mobile device 202 can alert the user of the service message 206, such as by an audio alert, a visual alert, a haptic alert, or any other type of alert. In some examples, the service message 206 includes a banner 502 and/or other alert that indicates to the user of the first mobile device 202 that the service message 206 has been automatically forwarded by the collaborative space 106 to the second mobile device 204.

In some examples, the GUI 500 also includes the service data 208 which may include the service time 214, the service date 216, and/or the service location 218. In this example GUI 500, the second mobile device 204 is associated with the second location information 226 that is matched with the service location 218 such that the service message 206 is automatically communicated to the second mobile device 204 at the service time 214 and/or the service date 216 in accordance with the techniques as described with reference to FIGS. 1 and 2. The GUI 500 may also receive user input to access service details, such as the service data 208, through an interactive link, such as a link to view the grocery delivery order.

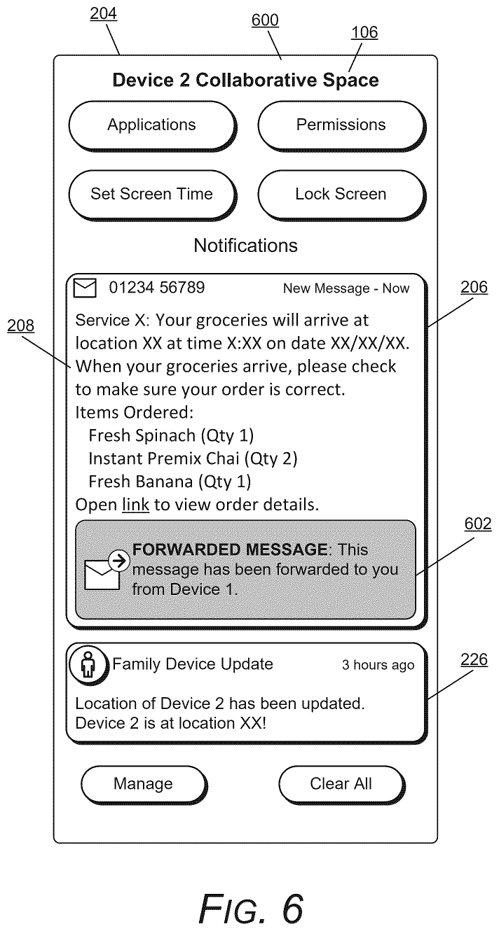

FIG. 6 illustrates an example GUI 600, which supports location based service message communication in accordance with one or more implementations as described herein. The example GUI 600 may implement aspects of the example system 100, as well as the example system 200 as shown and described with reference to FIGS. 1 and 2. For example, the GUI 600 may illustrate an example of the service message 206 displayed at the second mobile device 204 and/or the mobile device 102 that has been automatically communicated and/or forwarded to the second mobile device as described with reference to FIGS. 1 and 2

In the example GUI 600, the second mobile device 204 displays the service message 206 for a user of the second mobile device to view in the collaborative space 106. In this example GUI 600, the service message 206 includes information, such as the service data 208, indicating that the service is a product delivery, such as a grocery delivery. The second mobile device 204 can alert the user of the service message 206, such as by an audio alert, a visual alert, a haptic alert, or any other type of alert. In some examples, the service message 206 includes a banner 602 and/or other alert that indicates to the user of the second mobile device 204 that the service message 206 has been automatically forwarded by the collaborative space 106 to the second mobile device 204 from the first mobile device 202.

In some examples, the GUI 600 also includes the service data 208 which may include the service time 214, the service date 216, and/or the service location 218. In this example GUI 600, the second mobile device 204 is associated with the second location information 226 that is matched with the service location 218 such that the service message 206 is automatically communicated to the second mobile device at the service time 214 and/or the service date 216 in accordance with the techniques as described with reference to FIGS. 1 and 2. The GUI 600 may also receive user input to access service details, such as the service data 208, through an interactive link, such as a link to view the grocery delivery order.

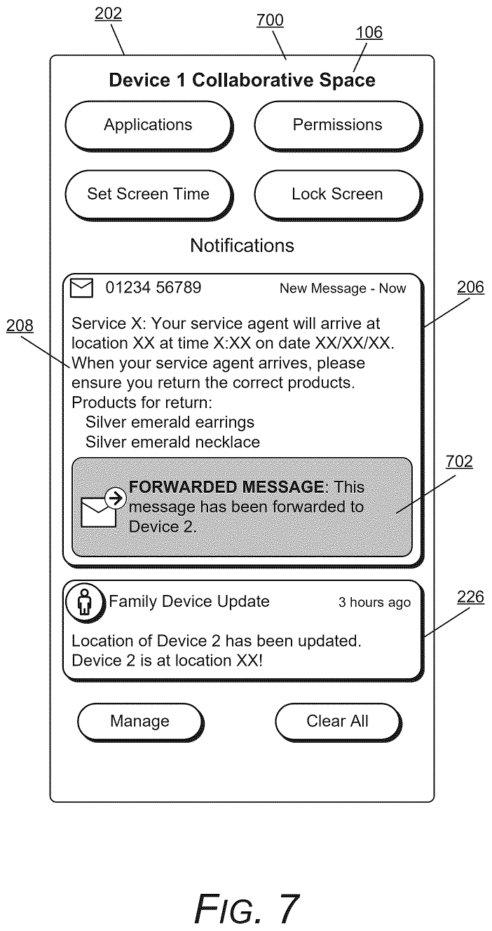

FIG. 7 illustrates an example GUI 700, which supports location based service message communication in accordance with one or more implementations as described herein. The example GUI 700 may implement aspects of the example system 100, as well as the example system 200 as shown and described with reference to FIGS. 1 and 2. For example, the GUI 700 may illustrate an example of the service message 206 displayed at the first mobile device 202 and/or the mobile device 102 that has been automatically communicated and/or forwarded to the second mobile device 204 as described with reference to FIGS. 1 and 2

In the example GUI 700, the first mobile device 202 displays the service message 206 for a user of the first mobile device to view in the collaborative space 106. In this example GUI 700, the service message 206 includes information, such as the service data 208, indicating that the service is a product return pickup. The first mobile device 202 can alert the user of the service message 206, such as by an audio alert, a visual alert, a haptic alert, or any other type of alert. In some examples, the service message 206 includes a banner 702 and/or other alert that indicates to the user of the first mobile device 202 that the service message 206 has been automatically forwarded by the collaborative space 106 to the second mobile device 204.

In some examples, the GUI 700 also includes the service data 208 which may include the service time 214, the service date 216, and/or the service location 218. In this example GUI 700, the second mobile device 204 is associated with the second location information 226 that is matched with the service location 218 such that the service message 206 is automatically communicated to the second mobile device 204 at the service time 214 and/or the service date 216 in accordance with the techniques as described with reference to FIGS. 1 and 2. The GUI 700 may also receive user input to access service details, such as the service data 208, through an interactive link, such as a link to view the products to be picked up by the service agent during the product return pickup.

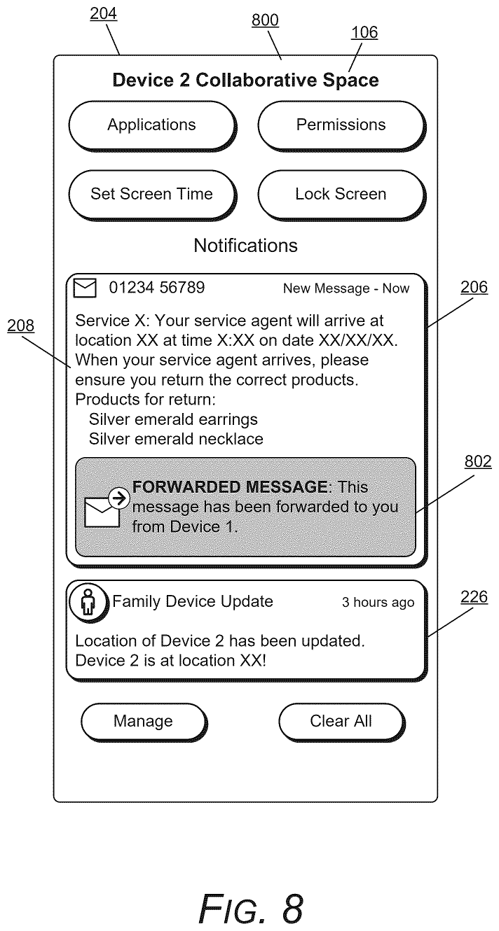

FIG. 8 illustrates an example GUI 800, which supports location based service message communication in accordance with one or more implementations as described herein. The example GUI 800 may implement aspects of the example system 100, as well as the example system 200 as shown and described with reference to FIGS. 1 and 2. For example, the GUI 800 may illustrate an example of the service message 206 displayed at the second mobile device 204 and/or the mobile device 102 that has been automatically communicated and/or forwarded to the second mobile device as described with reference to FIGS. 1 and 2

In the example GUI 800, the second mobile device 204 displays the service message 206 for a user of the second mobile device to view in the collaborative space 106. In this example GUI 800, the service message 206 includes information, such as the service data 208, indicating that the service is a product return pickup. The second mobile device 204 can alert the user of the service message 206, such as by an audio alert, a visual alert, a haptic alert, or any other type of alert. In some examples, the service message 206 includes a banner 802 and/or other alert that indicates to the user of the second mobile device 204 that the service message 206 has been automatically forwarded by the collaborative space 106 to the second mobile device 204 from the first mobile device 202.

In some examples, the GUI 800 also includes the service data 208 which may include the service time 214, the service date 216, and/or the service location 218. In this example GUI 800, the second mobile device 204 is associated with the second location information 226 that is matched with the service location 218 such that the service message 206 is automatically communicated to the second mobile device at the service time 214 and/or the service date 216 in accordance with the techniques as described with reference to FIGS. 1 and 2. The GUI 800 may also receive user input to access service details, such as the service data 208, through an interactive link, such as a link to view the products to be picked up by the service agent during the product return pickup.

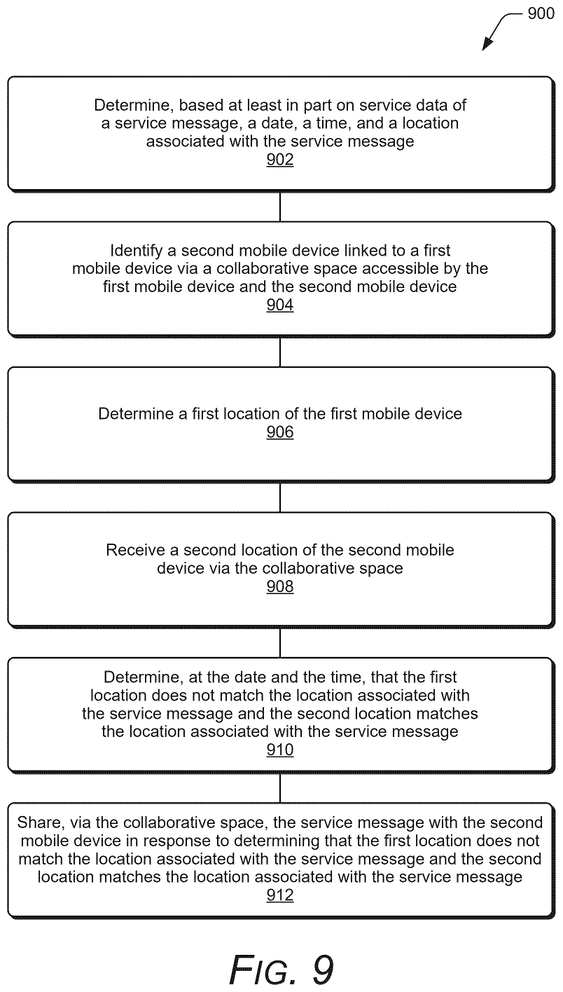

FIG. 9 illustrates one or more example methods 900 for location based service message communication. The order in which the method is described is not intended to be construed as a limitation, and any number or combination of the described method operations can be performed in any order to perform a method, or an alternate method.

At 902, a date, a time, and a location associated with a service message is determined based at least in part on service data of the service message. For instance, the first communication manager 212 can determine the service time 214, the service date 216, and the service location 218 based on the service data 208 of the service message 206. In implementations, the service message is ascertained by parsing a message received on the first mobile device. For instance, the first mobile device 202 can receive the received message 210, and the first communication manager 212 can parse the received message to ascertain that the received message is the service message 206. In implementations, the service data is extracted from the service message. For instance, the first communication manager 212 can extract the service data 208 including the service time 214, the service date 216, and/or the service location 218 from the service message 206. In implementations, the service message includes one or more of an authentication code, return pickup information, or service details. For example, the service message 206 can include an authentication code that needs to be recited and/or communicated to a service provider to receive the service outlined in the service message. Alternatively or in addition, the service message 206 can include return pickup information that outline the products that are to be returned to the service provider. Alternatively or in addition, the service message 206 can include service details that outline the service to be performed for the user of the first mobile device 202.

At 904, a second mobile device linked to the first mobile device via a collaborative space accessible by the first mobile device and the second mobile device is identified. For instance, the second mobile device 204 is identified to be linked to the first mobile device 202 via the collaborative space 106. In implementations, the second mobile device is identified based on a priority list comprising one or more devices linked to the first mobile device via the collaborative space. For instance, the second mobile device 204 is identified based on the device priority list 230 comprising the first mobile device 202 and/or the second mobile device. The device priority list 230 can specify a priority order along with lists of users and/or devices authorized to receive the service message 206. In implementations the priority list comprising the one or more devices is received via user input on a graphical user interface of the first mobile device. For instance, the device priority list 230 may be received via user input on a GUI (e.g., the example GUI 300) of the first mobile device 202.

At 906, a first location of the first mobile device is determined. For instance, the first location manager 220 may be implemented by the first mobile device 202 to determine the first location information 222 of the first mobile device.

At 908, a second location of the second mobile device is received via the collaborative space. For instance, the service message manager 118 implemented by the collaborative space 106 may receive the second location information 226 of the second mobile device 204 determined by the second location manager 224.

At 910, it is determined at the date and the time that the first location does not match the location associated with the service message and the second location matches the location associated with the service message. For instance, at the service time 214 and/or the service date 216, the service message manager 118 can determine that the first location information 222 does not match the service location 218 and that the second location information 226 matches the service location 218.

At 912, the service message is shared, via the collaborative space, with the second mobile device in response to determining that the first location does not match the location associated with the service message and the second location matches the location associated with the service message. For instance, the service message manager 118 implemented by the collaborative space 106 may transmit and/or forward the service message 206 to the second mobile device 204 in response to determining that the first location information 222 does not match the service location 218 and that the second location information 226 matches the service location 218.

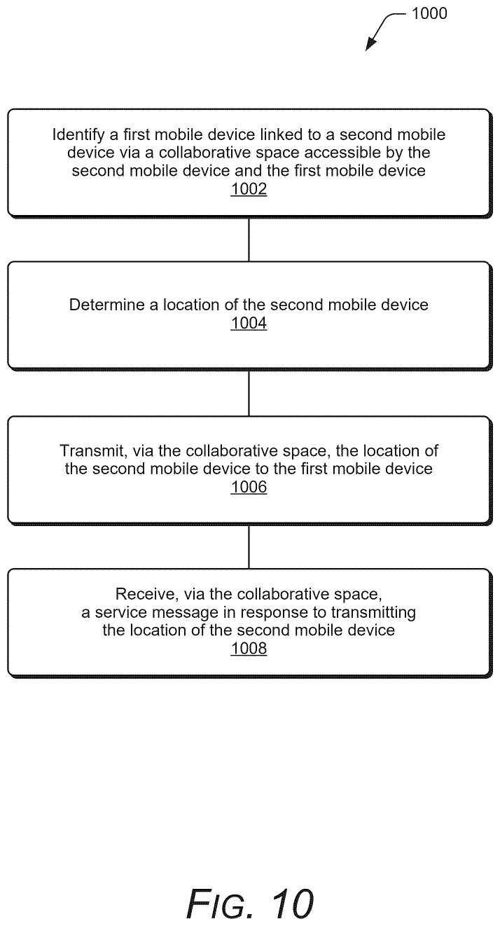

FIG. 10 illustrates one or more example methods 1000 for location based service message communication. The order in which the method is described is not intended to be construed as a limitation, and any number or combination of the described method operations can be performed in any order to perform a method, or an alternate method.

At 1002, a first mobile device is identified to be linked to a second mobile device via a collaborative space accessible by the second mobile device and the first mobile device. For instance, the first mobile device 202 is identified to be linked to the second mobile device 204 via the collaborative space 106 accessible by the first mobile device and the second mobile device.

At 1004, a location of the second mobile device is identified. For instance, the second mobile device 204 implements the second location manager 224 to determine the second location information 226.

At 1006, the location of the second mobile device is transmitted via the collaborative space to the first mobile device. For instance, the second location information 226 is transmitted to the service message manager 118 of the collaborative space 106 accessible by the first mobile device 202 and the second mobile device 204.

At 1008, a service message is received, via the collaborative space, in response to transmitting the location of the second mobile device. For instance, the second communication manager 228 receives the service message 206 from the service message manager 118 implemented by the collaborative space 106. In implementations, the service message includes service data parsed by the first mobile device. For instance, the service message 116 includes the service data 208 parsed by the first communication manager 212 of the first mobile device 202. In implementations, the service data includes a date, a time, and a location associated with the service message. For instance, the service data 208 includes the service time 214, the service date 216, and the service location 218 associated with the service message 206. In implementations, the service message is received, via the collaborative space, with instructions to display the service message based at least in part on the date and the time included in the service data. For instance, the service message 206 is received, via the collaborative space 106, with instructions to display the service message at the service time 214 and/or the service date 216 on a GUI (e.g., the GUI 400) of the second mobile device 204. In implementations, the instructions cause the second mobile device to display, via the collaborative space, the service message on a graphical user interface of the second mobile device at the date and the time included in the service data. For instance, the service message 206 is displayed, via the collaborative space 106, on a graphical user interface (e.g., the GUI 400) of the second mobile device at the service time 214 and the service date 216 included in the service data 208. In implementations, the service message includes one or more of an authentication code, return pickup information, or service details. For example, the service message 206 can include an authentication code that needs to be recited and/or communicated to a service provider to receive the service outlined in the service message. Alternatively or in addition, the service message 206 can include return pickup information that outline the products that are to be returned to the service provider. Alternatively or in addition, the service message 206 can include service details that outline the service to be performed for the user of the first mobile device 202 and/or the user of the second mobile device 204.

The example methods 900 and 1000 described with reference to respective FIGS. 9 and 10 in accordance with one or more implementations of location based service message communication, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 11 illustrates various components of an example device 1100, which can implement aspects of the techniques and features for location based service message communication, as described herein. The example device 1100 can be implemented as any of the devices described with reference to the previous FIGS. 1 through 10, such as any type of a wireless device, mobile device (e.g., the mobile device 102), mobile phone, flip phone, client device, companion device, paired device, display device, tablet, computing, communication, entertainment, gaming, media playback, and/or any other type of computing, consumer, and/or electronic device. For example, the mobile device 102, the first mobile device 202, and/or the second mobile device 204 described with reference to FIGS. 1 through 10 may be implemented as the example device 1100.

The example device 1100 can include various, different communication devices 1102 that enable wired and/or wireless communication of device data 1104 with other devices. The device data 1104 can include any of the various device's data and content that is generated, processed, determined, received, stored, and/or communicated from one computing device to another. Generally, the device data 1104 can include any form of audio, video, image, graphics, and/or electronic data that is generated by applications executing on a device. The communication devices 1102 can also include transceivers for cellular phone communication and/or for any type of network data communication.

The example device 1100 can also include various, different types of data input/output (I/O) interfaces 1106, such as data network interfaces that provide connection and/or communication links between the devices, data networks, and other devices. The I/O interfaces 1106 can be used to couple the device to any type of components, peripherals, and/or accessory devices, such as a computer input device that may be integrated with the example device 1100. The I/O interfaces 1106 may also include data input ports via which any type of data, information, media content, communications, messages, and/or inputs can be received, such as user inputs to the device, as well as any type of audio, video, image, graphics, and/or electronic data received from any content and/or data source.

The example device 1100 includes a processor system 1108 of one or more processors (e.g., any of microprocessors, controllers, and the like) and/or a processor and memory system implemented as a system-on-chip (SoC) that processes computer-executable instructions. The processor system 1108 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 1110. The example device 1100 may also include any type of a system bus or other data and command transfer system that couples the various components within the device. A system bus can include any one or combination of different bus structures and architectures, as well as control and data lines.

The example device 1100 also includes memory and/or memory devices 1112 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 1112 include volatile memory and non-volatile memory, fixed and removable media devices, and any suitable memory device or electronic data storage that maintains data for computing device access. The memory devices 1112 can include various implementations of random-access memory (RAM), read-only memory (ROM), flash memory, and other types of storage media in various memory device configurations. The example device 1100 may also include a mass storage media device.

The memory devices 1112 (e.g., as computer-readable storage memory) provide data storage mechanisms, such as to store the device data 1104, other types of information and/or electronic data, and various device applications 1114 (e.g., software applications and/or modules). For example, an operating system 1116 can be maintained as software instructions with a memory device 1112 and executed by the processor system 1108 as a software application. The device applications 1114 may also include a device manager, such as any form of a control application, software application, signal processing and control module, code that is specific to a particular device, a hardware abstraction layer for a particular device, and so on.

In this example, the device 1100 includes a configuration manager 1118 that implements various aspects of the described features and techniques described herein. The configuration manager 1118 can be implemented with hardware components and/or in software as one of the device applications 1114, such as when the example device 1100 is implemented as the mobile device 102, the first mobile device 202, and/or the second mobile device 204 described with reference to FIGS. 1 through 10. An example of the configuration manager 1118 is the service message manager 118, the communication manager 112, the location manager 110, the first communication manager 212, the first location manager 220, the second communication manager 228, and/or the second location manager 224 implemented in the mobile device 102, the first mobile device 202, and/or the second mobile device 204 such as a software application and/or as hardware components in the wireless device. In implementations, the configuration manager 1118 may include independent processing, memory, and logic components as a computing and/or electronic device integrated with the example device 1100.

The example device 1100 can also include a microphone 1120 and/or camera devices 1122, as well as proximity and/or motion sensors 1124, such as may be implemented as components of an inertial measurement unit (IMU). The proximity and/or motion sensors 1124 can be implemented with various sensors, such as a gyroscope, an accelerometer, and/or other types of motion sensors to sense motion of the device. The motion sensors 1124 can generate sensor data vectors having three-dimensional parameters (e.g., rotational vectors in x, y, and z-axis coordinates) indicating location, position, acceleration, rotational speed, and/or orientation of the device. The example device 1100 can also include one or more power sources 1126, such as when the device is implemented as a wireless device and/or the mobile device 102. The power sources may include a charging and/or power system, and can be implemented as a flexible strip battery, a rechargeable battery, a charged super-capacitor, and/or any other type of active or passive power source.

The example device 1100 can also include an audio and/or video processing system 1128 that generates audio data for an audio system 1130 and/or generates display data for a display system 1132. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 1100. Alternatively, the audio system and/or the display system are external, peripheral components to the example device.

Although implementations of location based service message communication have been described in language specific to features and/or methods, the appended claims are not necessarily limited to the specific features or methods described. Rather, the specific features and methods are disclosed as example implementations of location based service message communication, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a first mobile device, including: a memory; and at least one processor coupled with the memory and configured to cause the first mobile device to: determine, based at least in part on service data of a service message, a date, a time, and a location associated with the service message; identify a second mobile device linked to the first mobile device via a collaborative space accessible by the first mobile device and the second mobile device; determine a first location of the first mobile device; receive a second location of the second mobile device via the collaborative space; determine, at the date and the time, that the first location does not match the location associated with the service message and the second location matches the location associated with the service message; and share, via the collaborative space, the service message with the second mobile device in response to determining that the first location does not match the location associated with the service message and the second location matches the location associated with the service message.

In some aspects, the techniques described herein relate to a first mobile device, wherein the memory is configured to cause the first mobile device to ascertain the service message by parsing a message received on the first mobile device.

In some aspects, the techniques described herein relate to a first mobile device, wherein the at least one processor coupled with the memory is configured to cause the first mobile device to extract the service data from the service message.

In some aspects, the techniques described herein relate to a first mobile device, wherein the service message includes one or more of an authentication code, return pickup information, or service details.

In some aspects, the techniques described herein relate to a first mobile device, wherein the first mobile device is pre-authorized to share the service message with the second mobile device.

In some aspects, the techniques described herein relate to a first mobile device, wherein the second mobile device is identified based on a priority list comprising one or more devices linked to the first mobile device via the collaborative space.

In some aspects, the techniques described herein relate to a first mobile device, wherein the priority list comprising the one or more devices is received via user input on a graphical user interface of the first mobile device.

In some aspects, the techniques described herein relate to a second mobile device, including: a memory; and at least one processor coupled with the memory and configured to cause the second mobile device to: identify a first mobile device linked to the second mobile device via a collaborative space accessible by the second mobile device and the first mobile device; determine a location of the second mobile device; transmit, via the collaborative space, the location of the second mobile device to the first mobile device; and receive, via the collaborative space, a service message in response to transmitting the location of the second mobile device.

In some aspects, the techniques described herein relate to a second mobile device, wherein the service message includes service data parsed by the first mobile device.

In some aspects, the techniques described herein relate to a second mobile device, wherein the service data includes a date, a time, and a location associated with the service message.

In some aspects, the techniques described herein relate to a second mobile device, wherein the at least one processor coupled with the memory is configured to cause the second mobile device to receive, via the collaborative space, instructions from the first mobile device to display the service message based at least in part on the date and the time included in the service data.

In some aspects, the techniques described herein relate to a second mobile device, wherein the at least one processor coupled with the memory is configured to cause the second mobile device to display, via the collaborative space, the service message on a graphical user interface of the second mobile device at the date and the time included in the service data.

In some aspects, the techniques described herein relate to a second mobile device, wherein the service message includes one or more of an authentication code, return pickup information, or service details.

In some aspects, the techniques described herein relate to a method, including: determining, based at least in part on service data of a service message, a date, a time, and a location associated with the service message; identifying a second mobile device linked to a first mobile device via a collaborative space accessible by the first mobile device and the second mobile device; determining a first location of the first mobile device; receiving a second location of the second mobile device via the collaborative space; determining, at the date and the time, that the first location does not match the location associated with the service message and the second location matches the location associated with the service message; and sharing, via the collaborative space, the service message with the second mobile device in response to determining that the first location does not match the location associated with the service message and the second location matches the location associated with the service message.

In some aspects, the techniques described herein relate to a method, including ascertaining the service message by parsing a message received on the first mobile device.

In some aspects, the techniques described herein relate to a method, including extracting the service data from the service message on the first mobile device.

In some aspects, the techniques described herein relate to a method, wherein the service message includes one or more of an authentication code, return pickup information, or service details.

In some aspects, the techniques described herein relate to a method, wherein the first mobile device is pre-authorized to share the service message with the second mobile device.

In some aspects, the techniques described herein relate to a method, wherein the second mobile device is identified based on a priority list comprising one or more devices linked to the first mobile device via the collaborative space.

In some aspects, the techniques described herein relate to a method, wherein the priority list comprising the one or more devices is received via user input on a graphical user interface of the first mobile device.

1. A first mobile device, comprising:
a memory; and
at least one processor coupled with the memory and configured to cause the first mobile device to:
determine, based at least in part on service data of a service message, a date, a time, and a location associated with the service message;
identify a second mobile device linked to the first mobile device via a collaborative space accessible by the first mobile device and the second mobile device;
determine a first location of the first mobile device;
receive a second location of the second mobile device via the collaborative space;
determine, at the date and the time, that the first location does not match the location associated with the service message and the second location matches the location associated with the service message; and
share, via the collaborative space, the service message with the second mobile device in response to determining that the first location does not match the location associated with the service message and the second location matches the location associated with the service message.

2. The first mobile device of claim 1, wherein the at least one processor coupled with the memory is configured to cause the first mobile device to ascertain the service message by parsing a message received on the first mobile device.

3. The first mobile device of claim 1, wherein the at least one processor coupled with the memory is configured to cause the first mobile device to extract the service data from the service message.

4. The first mobile device of claim 1, wherein the service message includes one or more of an authentication code, return pickup information, or service details.

5. The first mobile device of claim 1, wherein the first mobile device is pre-authorized to share the service message with the second mobile device.

6. The first mobile device of claim 1, wherein the second mobile device is identified based on a priority list comprising one or more devices linked to the first mobile device via the collaborative space.

7. The first mobile device of claim 6, wherein the priority list comprising the one or more devices is received via user input on a graphical user interface of the first mobile device.

8. A second mobile device, comprising:
a memory; and
at least one processor coupled with the memory and configured to cause the second mobile device to:
identify a first mobile device linked to the second mobile device via a collaborative space accessible by the second mobile device and the first mobile device;
determine a location of the second mobile device;
transmit, via the collaborative space, the location of the second mobile device to the first mobile device; and
receive, via the collaborative space, a service message in response to transmitting the location of the second mobile device.

9. The second mobile device of claim 8, wherein the service message includes service data parsed by the first mobile device.

10. The second mobile device of claim 9, wherein the service data includes a date, a time, and a location associated with the service message.

11. The second mobile device of claim 10, wherein the at least one processor coupled with the memory is configured to cause the second mobile device to receive, via the collaborative space, instructions from the first mobile device to display the service message based at least in part on the date and the time included in the service data.

12. The second mobile device of claim 10, wherein the at least one processor coupled with the memory is configured to cause the second mobile device to display, via the collaborative space, the service message on a graphical user interface of the second mobile device at the date and the time included in the service data.

13. The second mobile device of claim 8, wherein the service message includes one or more of an authentication code, return pickup information, or service details.

14. A method, comprising:
determining, based at least in part on service data of a service message, a date, a time, and a location associated with the service message;
identifying a second mobile device linked to a first mobile device via a collaborative space accessible by the first mobile device and the second mobile device;
determining a first location of the first mobile device;
receiving a second location of the second mobile device via the collaborative space;
determining, at the date and the time, that the first location does not match the location associated with the service message and the second location matches the location associated with the service message; and
sharing, via the collaborative space, the service message with the second mobile device in response to determining that the first location does not match the location associated with the service message and the second location matches the location associated with the service message.

15. The method of claim 14, comprising ascertaining the service message by parsing a message received on the first mobile device.

16. The method of claim 14, comprising extracting the service data from the service message on the first mobile device.

17. The method of claim 14, wherein the service message includes one or more of an authentication code, return pickup information, or service details.

18. The method of claim 14, wherein the first mobile device is pre-authorized to share the service message with the second mobile device.

19. The method of claim 14, wherein the second mobile device is identified based on a priority list comprising one or more devices linked to the first mobile device via the collaborative space.

20. The method of claim 19, wherein the priority list comprising the one or more devices is received via user input on a graphical user interface of the first mobile device.
